(19) United States
(12) Patent Application Publication
(10) Pub. No.: US 2023/0330638 A1
(43) Pub. Date: Oct. 19, 2023

(54) LAYERED CATALYTIC ARTICLE AND PROCESS FOR PREPARING THE CATALYTIC ARTICLE

(71) Applicant: BASF CORPORATION, Florham Park, NJ (US)

(72) Inventors: Chun Yu CHEN, Shanghai (CN); Xiaolai ZHENG, Iselin, NJ (US); Wei Liang WANG, Shanghai (CN); Attilio SIANI, Shanghai (CN); Pascaline TRAN, Iselin, NJ (US)

(21) Appl. No.: 18/044,647

(22) PCT Filed: Sep. 9, 2021
(86) PCT No.: PCT/US2021/049571

§ 371 Date: Mar. 9, 2023

(30) Foreign Application Priority Data
Sep. 11, 2020 (WO) PCT/CN2020/114794

(51) Int. Cl. B01J 23/46; B01J 23/44; B01J 23/10; B01J 21/04; B01J 35/00; B01J 37/02; B01D 53/94; F01N 3/28

(52) U.S. Cl. CPC B01J 23/464; B01J 23/44; B01J 23/10; B01J 21/04; B01J 35/0006; B01J 35/0066; B01J 37/0244; B01J 37/0228; B01D 53/945; B01D 53/9472; B01D 53/9468; F01N 3/2825; B01D 2255/1023; B01D 2255/1025; B01D 2255/1021; B01D 2255/9032; B01D 2255/9022; B01D 2255/908; B01D 2255/407; B01D 2258/01; B01D 2257/502; B01D 2257/702; B01D 2257/404; F01N 2370/02; F01N 2330/06; F01N 2510/0684

(57) ABSTRACT

Described herein is a layered catalytic article which includes a) a top layer including a front zone and a rear zone, where the front zone includes a palladium component and a rhodium component, supported individually or together on a support, and the rear zone includes a platinum component, a rhodium component and optionally a palladium component, supported individually or together on a support; b) a bottom layer including a platinum component and a palladium component supported individually or together on a support; and c) a substrate. Also described herein are an exhaust treatment system including the layered catalytic article and a method of using the layered catalytic article for abatement of hydrocarbons, carbon monoxide and nitrogen oxides in an exhaust stream.

### CROSS-REFERENCE TO RELATED APPLICATIONS

This application claims the benefit of priority to International Application No. PCT/CN2020/114794, filed Sep. 11, 2020 in its entirety.

### FIELD OF THE INVENTION

The present invention relates to a layered catalytic article useful for treatment of exhaust gases and a process for preparation of the layered catalytic article. Particularly, the present invention relates to a layered catalytic article having zoned configuration and a process for preparation of the same.

### BACKGROUND OF THE INVENTION

In order to meet emission standards for unburned hydrocarbons (HO), carbon monoxide (CO) and nitrogen oxides (NOx) contaminants, catalytic converters containing a three-way conversion (TWC) catalyst (hereinafter interchangeably referred to as TWO catalyst, or TWC) have been utilized for several years. The TWO catalysts are well known to simultaneously oxidize unburnt hydrocarbons and carbon monoxide and reduce nitrogen oxides in the exhaust streams from internal combustion engines, especially gasoline engines.

The TWO catalysts utilize platinum group metals (PGMs) as the catalytic active species. In particular, palladium is typically used as the major platinum group metal together with a minor amount of rhodium. In recent years, a great challenge in the field of TWO catalysts is the increasing manufacturing cost, since an acute supply shortage of palladium in the market drove a continuous growth of palladium price, which is approximately 2.6 times higher than that of platinum now. At the same time, the platinum price is expected to be decreased due to decreasing production volumes of diesel-powered vehicles which typically use diesel oxidation catalysts containing platinum as the major catalytic active species. Accordingly, TWO catalysts comprising platinum in place of at least a portion of palladium are desirable to reduce the cost of the catalyst substantially. However, it is expected that simple replacement of palladium with platinum will result in undesirable or unsatisfactory performance of the catalyst. Various TWO catalysts comprising an amount of platinum have been developed in the past few decades.

With more and more stringent regulations on engine exhaust, there is a continuing need to provide TWC catalysts which provide efficient removal of HC, CO and NOx and can be produced with reduced cost.

### SUMMARY OF THE INVENTION

The object of the present invention is to provide a catalytic article comprising platinum to replace an amount of palladium used otherwise in TWO catalysts, which has comparable or even improved overall catalytic performance in terms of abatement of HC, CO and NOx.

Accordingly, the present invention provides a layered catalytic article comprising:
a) a top layer comprising a front zone and a rear zone, wherein the front zone comprises a palladium component and a rhodium component, supported individually or together on a support, and the rear zone comprises a platinum component, a rhodium component and optionally a palladium component, supported individually or together on a support;
b) a bottom layer comprising a platinum component and a palladium component supported individually or together on a support; and
c) a substrate,
wherein the palladium component and the platinum component are present in the layered catalytic article at a Pd/Pt weight ratio in the range of about 20:1 to about 5:4, calculated as palladium and platinum elements.

In another aspect, the present invention provides a process for preparation of the layered catalytic article as described herein, including
depositing a bottom coat slurry on the substrate to obtain a bottom layer;
depositing a top coat front zone slurry on the bottom layer of a certain length from one end of the substrate to obtain a front zone of a top layer; and
depositing a top coat rear zone slurry on the bottom layer of the remaining length of the substrate to obtain a rear zone of a top layer.

In a further aspect, the present invention provides an exhaust treatment system comprising the layered catalytic article as described herein located downstream of a gasoline engine.

In yet another aspect, the present invention provides a method for treating an exhaust stream including contacting the exhaust stream with the layered catalytic article or the exhaust treatment system as described herein.

### BRIEF DESCRIPTION OF THE DRAWINGS

FIG. 1A is a diagram of Pd/Rh bimetal catalytic article with an exemplary layered configuration as prepared according to Example 1;

FIG. 1B is a diagram of Pd/Pt/Rh tri-metal catalytic article with an exemplary layered configuration as prepared according to Example 2;

FIG. 2A is a diagram of Pd/Rh bi-metal catalytic article with an exemplary layered configuration as prepared according to Example 3;

FIG. 2B is a diagram of Pd/Pt/Rh tri-metal catalytic article with an exemplary layered configuration as prepared according to Example 4;

FIG. 3A is a schematic representation of Pd/Pt/Rh tri-metal catalytic article designs with layered and zoned configurations according to some embodiments of the present invention;

FIG. 3B is a diagram of Pd/Pt/Rh tri-metal catalytic article with an exemplary layered and zoned configuration as prepared according to Example 5;

FIG. 4A is a diagram of Pd/Rh bi-metal catalytic article with an exemplary layered and zoned configuration as prepared according to Example 6;

FIG. 4B is a diagram of Pd/Pt/Rh tri-metal catalytic article with an exemplary layered and zoned configuration as prepared according to Example 7;

FIG. 5 is a diagram of Pd/Pt/Rh tri-metal catalytic article with an exemplary layered and zoned configuration as prepared according to Example 8;

FIG. 6 is a graph showing tail-pipe emissions in terms of THC, CO and NOx after treatment of the engine exhaust with the samples of Group 1.

FIG. 7 is a graph showing tail-pipe emissions in terms of THC, CO and NOx after treatment of the engine exhaust with the samples of Group 2.

FIG. 8 is a graph showing tail-pipe emissions in terms of THC, CO and NOx after treatment of the engine exhaust with the samples of Group 3.

FIG. 9 is a graph showing tail-pipe emissions in terms of THC, CO and NOx after treatment of the engine exhaust with the samples of Group 4.

FIG. 10 is a graph showing tail-pipe emissions in terms of THC, CO and NOx after treatment of the engine exhaust with the samples of Group 5.

### DETAILED DESCRIPTION OF THE INVENTION

The present invention will be described in details hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner, That is, e.g., further components or elements may be present. The expressions “consists of” or “consists essentially of” or cognates may be embraced within “comprises” or cognates.

The term “about” used throughout the specification is used to describe and account for small fluctuations without significantly altering physiochemical properties. For example, the term “about” refers to less than or equal to ±5%, such as less than or equal to ±2%, less than or equal to ±1%, less than or equal to ±0.5%, less than or equal to ±0.2%, less than or equal to ±0.1% or less than or equal to ±0.05%. A value modified by the term “about” of course includes the specific value. For instance, “about 5.0” must include 5.0.

The terms “palladium component”, “platinum component” and “rhodium component” are intended to describe the presence of those platinum group metals in any possible valence state, which may be for example respective metal or the metal oxide as the catalytically active form, or may be for example respective metal compound, complex, or the like which, upon calcination or use of the catalyst, decomposes or otherwise converts to a catalytically active form.

The term layered catalytic article refers to a catalytic article in which a substrate is coated with catalyst compositions in a layered fashion.

The term “front zone” is used interchangeably with “inlet zone”, referring to the first zone which an exhaust stream from an engine will contact with. The term “rear zone” is used interchangeably with “outlet zone”, referring to the zone subsequent to the first zone which the exhaust stream flow from the first zone will contact with.

The term “NOx” refers to nitrogen oxides, such as NO and/or NO₂.

According to one aspect of the present invention, a layered catalytic article is provided, which comprises:
a) a top layer comprising a front zone and a rear zone, wherein the front zone comprises a palladium component and a rhodium component, supported individually or together on a support, and the rear zone comprises a platinum component, a rhodium component and optionally a palladium component, supported individually or together on a support;
b) a bottom layer comprising a platinum component and a palladium component supported individually or together on a support; and
c) a substrate,
wherein the palladium component and the platinum component are present in the layered catalytic article at a Pd/Pt weight ratio in the range of about 20:1 to about 5:4, calculated as palladium and platinum elements.

The layered catalytic article according to the present invention is effective for carrying out three-way conversion (TWC).

In some embodiments, the front zone of the top layer in the layered catalytic article according to the present invention is substantially free of a platinum component or substantially free of any PGMs other than Pd and Rh. Alternatively or additionally, the rear zone of the top layer in the layered catalytic article according to the present invention comprises a platinum component, a rhodium component and a palladium component. Moreover, the rear zone of the top layer in the layered catalytic article according to the present invention is substantially free of any PGMs other than Pt, Pd and Rh. Alternatively or additionally, the bottom layer in the layered catalytic article according to the present invention is substantially free of a rhodium component or substantially free of any PGMs other than Pt and Pd.

Reference to a zone or layer that is substantially free of a PGM is intended to mean no PGM as specified has been intentionally added or used in the zone or layer. It will be appreciated by those of skill in the art that migration of trace amounts of PGM(s) into the zone or layer may inadvertently occur during loading, coating and/or calcining, such that trace amounts of the specified PGM(s) may be present in the zone or layer. There is generally less than about 1 wt %, including less than about 0.75 wt %, less than about 0.5 wt %, less than about 0.25 wt %, or less than about 0.1 wt %, of the specified PGM(s).

According to the present invention, there is no particular restriction to the relative lengths of the front zone and rear zone. In some embodiments, the top layer is zoned such that the front zone comprises about 20 to about 70% of the substrate length and the rear zone comprises about 30 to about 80% of the substrate length. In some other embodiments, the top layer is zoned such that the front zone comprises about 30 to about 60% of the substrate length and the rear zone comprises about 40 to about 70% of the substrate length. In some further embodiments, the top layer is zoned such that the front zone comprises about 30 to about 50% of the substrate length and the rear zone comprises about 50 to about 70% of the substrate length. It will be understood that the front zone and rear zone may be exactly adjoining, but may alternatively be overlapped or be interrupted with a gap, depending on the accuracy of the process for applying the coats for the two zones of the top layer.

The weight ratio of the palladium component to the platinum component comprised in the layered catalytic article according to the present invention may vary in the range of about 20:1 to about 5:4, calculated as palladium and platinum elements. For example, the weight ratio of the palladium component to the platinum component comprised in the layered catalytic article may be no less than about 4:3, no less than about 3:2, or no less than about 2:1. The weight ratio of the palladium component to the platinum component comprised in the layered catalytic article may be no greater than about 15:1, no greater than about 10:1, no greater than about 6:1, or no greater than about 5:1, or no greater than about 4:1. Accordingly, in some preferable embodiments, the palladium component and the platinum component may be comprised in the layered catalytic article according to the present invention at a Pd/Pt weight ratio calculated as palladium and platinum elements in the range of about 15:1 to about 4:3, about 10:1 to about 3:2, about 6:1 to about 3:2, about 5:1 to about 2:1, or about 4:1 to about 2:1.

There is no particular restriction to the weight ratio of rhodium component to the palladium component or the platinum component or the sum of the palladium and platinum components in the layered catalytic article according to the present invention. For example, the weight ratio of the rhodium component to the sum of the palladium and platinum components in the layered catalytic article according to the present invention may be in the range of about 2:3 to about 1:200, about 1:2 to about 1:50, about 1:3 to about 1:20, or about 1:3 to about 1:10, calculated as respective elements.

The weight ratio of the palladium component to the platinum component to the rhodium component in the layered catalytic article according to the present invention may be for example in the range of about 10:1:0.2 to about 2:1:1 or about 5:1:0.5 to about 2:1:1, calculated as respective elements.

In the bottom layer on the substrate in the layered catalytic article according to the present invention, the palladium component may be loaded in an amount of about 1 to about 250 g/ft³, about 5 to about 150 g/ft³, or about 5 to about 100 g/ft³, calculated as palladium element. The platinum component may be loaded in an amount of about 0.5 to about 150 g/ft³, about 1 to about 100 g/ft³, or about 5 to about 50 g/ft³, calculated as platinum element. Particularly, the palladium component and the platinum component may be present in the bottom layer on the substrate in the layered catalytic article according to the present invention at a Pd/Pt weight ratio in the range of about 3:1 to about 2:3, or about 2.5:1 to about 1:1, calculated as palladium and platinum elements.

In the top layer in the layered catalytic article according to the present invention, the palladium component may be loaded in an amount of about 0.5 to about 250 g/ft³, about 1 to about 150 g/ft³, or about 2 to about 100 g/ft³ in each zone, calculated as palladium element. The loadings of the palladium component in the front zone and in the rear zone may be the same or different. The rhodium component may be loaded in an amount of about 0.5 to about 100 g/ft³, about 1 to about 50 g/ft³, or about 2 to about 20 g/ft³ in each zone, calculated as rhodium element. The loadings of the rhodium component in the front zone and in the rear zone may also be the same or different. The platinum component may be loaded in an amount of about 0.5 to about 150 g/ft³, about 1 to about 100 g/ft³, or about 5 to about 50 g/ft³, calculated as platinum element.

In some particular embodiments, the platinum component in the rear zone of the top layer may comprise about 30% to about 70%, about 40% to about 60%, or about 50% of the total amount of the platinum component in the layered catalytic article according to the present invention.

In the front zone of the top layer in the layered catalytic article according to the present invention, the palladium component and the rhodium component may be loaded at a Pd/Rh weight ratio in the range of about 50:1 to about 1:1, about 10:1 to about 1.5:1, about 5:1 to about 1.5:1, or about 4:1 to about 2:1, calculated as palladium and rhodium elements. In the rear zone of the top layer in the layered catalytic article according to the present invention, the platinum component and the rhodium component may be loaded at a Pt/Rh weight ratio in the range of about 10:1 to about 1:5, about 2:1 to about 1:2, or about 1.5:1 to about 1:1.5, calculated as platinum and rhodium elements.

The total loading of the top layer may be in the range of about 1.5 to 4.0 g/in³ or about 2 to 3 g/in³ and the loading of the bottom layer is in the range of about 0.75 to 2.0 g/in³.

Within the context of the present invention, “support” refers to a material receiving and carrying one or more platinum group metals, which may also receive and carry other components such as stabilizers, promoters and binders. The supports may be selected from refractory metal oxides, oxygen storage components and any combinations thereof.

The refractory metal oxide, a widely used support for the platinum group metals in exhaust treatment catalytic articles, is generally a high surface area alumina-based material, zirconia-based material or a combination thereof. Within the context of the present invention, “alumina-based material” refers to a material comprising alumina as a base and optionally a dopant. Similarly, “zirconia-based material” refers to a material comprising zirconia as a base and optionally a dopant.

Suitable examples of the alumina-based materials include, but are not limited to alumina, for example a mixture of the gamma and delta phases of alumina which may also contain substantial amounts of eta, kappa and theta alumina phases, lanthana doped alumina, baric doped alumina, ceria doped alumina, zirconia doped alumina, ceria-zirconia doped alumina, lanthana-zirconia doped alumina, baric-lanthana doped alumina, baria-lanthana-neodymia doped alumina, and any combinations thereof. Suitable examples of the zirconia-based materials include, but are not limited to zirconia, lanthana doped zirconia, yttria doped zirconia, neodymia doped zirconia, praseodymia doped zirconia, titanic doped zirconia, titanic-lanthana doped zirconia, lanthana-yttria doped zirconia, and any combinations thereof. For example, the refractory metal oxide is selected from alumina, lanthana doped alumina, lanthana-zirconia doped alumina, ceria doped alumina, zirconia doped alumina, ceria-zirconia doped alumina, zirconia, lanthana doped zirconia, lanthana-yttria doped zirconia, and any combinations thereof. Generally, the amount of the refractory metal oxide is 10 to 90 wt. %, based on the total weight of the bottom or top layer.

The oxygen storage component (OSC) refers to an entity that has a multi-valence state and can actively react with oxidants such as oxygen or nitrogen oxides under oxidative conditions, or reacts with reductants such as carbon monoxide (CO) or hydrogen under reduction conditions, Typically, the OSC comprise one or more reducible rare earth metal oxides, such as ceria. The OSC may also comprise one or more of lanthana, praseodymia, neodymia, europia, samaria, ytterbia, yttria, zirconia, hafnia, and any combinations thereof to constitute a composite oxide with ceria. Preferably, the oxygen storage component is selected from ceria-zirconia composite oxide and rare earth-stabilized ceria-zirconia composite oxide. Generally, the amount of oxygen storage component is 20 to 80 wt. %, based on the total weight of the bottom or top layer.

It is to be understood that the supports for the platinum component, the palladium component and the rhodium component in the layered catalytic article may be the same or different. It is also to be understood that the supports for the same platinum group metal in different layers or in different zones in the layered catalytic article may be the same or different.

In some embodiments, the layered catalytic article according to the present invention comprises:
a) a top layer comprising a front zone and a rear zone, wherein the front zone comprises a palladium component and a rhodium component, supported individually or together on a support, and the rear zone comprises a platinum component, a palladium component and a rhodium component, supported individually or together on a support;
b) a bottom layer comprising a platinum component and a palladium component supported individually or together on a support; and
c) a substrate,
wherein the support in each case is independently a refractory metal oxide selected from alumina, lanthana doped alumina, lanthana-zirconia doped alumina, ceria doped alumina, zirconia, zirconia doped alumina, ceria-zirconia doped alumina, lanthana doped zirconia and lanthana-yttria doped zirconia, an oxygen storage component selected from ceria-zirconia composite oxide and rare earth-stabilized ceria-zirconia composite oxide, or any combinations thereof, and
wherein the palladium component and platinum component are present in the layered catalytic article at a Pd/Pt weight ratio in the range of about 20:1 to about 5:4, calculated as palladium and platinum elements.

In some illustrative embodiments, the layered catalytic article according to the present invention comprises:
a) a top layer comprising a front zone and a rear zone, wherein the front zone comprises a palladium component individually supported on a combination of alumina and an oxygen storage component and a rhodium component individually supported on a combination of alumina or zirconia and an oxygen storage component, and the rear zone comprises a palladium component supported individually on a combination of alumina and an oxygen storage component, a platinum component supported on an oxygen storage component, and a rhodium component, wherein a part of the rhodium component is supported on the oxygen storage component together with the platinum component and the remaining part of the rhodium component is supported on alumina or zirconia, wherein the oxygen storage component in each case is independently selected from cerin-zirconia composite oxide and rare earth-stabilized ceria-zirconia composite oxide;
b) a bottom layer comprising a platinum component and a palladium component, wherein the platinum component is supported together with a part of palladium component on coria doped alumina and the remaining part of the palladium component is supported on an oxygen storage component selected from ceria-zirconia composite oxide and rare earth-stabilized ceria-zirconia composite oxide; and
c) a substrate, wherein the palladium component and platinum component are present in the layered catalytic article at a Pd/Pt weight ratio in the range of about 20:1 to about 5:4, about 15:1 to about 4; 3, about 10:1 to about 3:2, about 6:1 to about 3:2, about 5:1 to about 2:1 or about 4:1 to about 2:1, calculated as palladium and platinum elements.

According to the above illustrative embodiments, the palladium component supported on the oxygen storage component in the bottom layer may comprise about 50% to about 95% or about 70% to about 95% of the total amount of the palladium component in the bottom layer. Alternatively or additionally, the rhodium component supported on the oxygen storage component in the rear zone of the top layer may comprise about 50% to about 90% or about 60% to about 80% of the total amount of the rhodium component in the rear zone.

In some particular embodiments of the layered catalytic article according to the present invention, the bottom layer is applied on the substrate and the top layer is applied on the bottom layer without any intermediate layers.

The substrate as used herein refers to a structure that is suitable for withstanding conditions encountered in exhaust streams of combustion engines on which the catalytic compositions carried, typically in the form of a washcoat. The substrate is generally a ceramic or metal honeycomb structure having fine, parallel gas flow passages extending from one end of the structure to the other.

The term “washcoat” has its usual meaning in the art and refers to a thin, adherent coating of a catalytic or other material applied to a substrate. A washcoat is generally formed by preparing a slurry containing a certain solid content (e.g., 15-60% by weight) of particles in a liquid vehicle, which is then applied onto a substrate, dried and calcined to provide a washcoat layer.

Metal materials useful for constructing the substrate may include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt % of the alloy. e.g. 10 to 25 wt % of chromium, 3 to 8% of aluminium, and up to 20 wt % of nickel. The alloys may also contain small or trace amounts of one or more metals such as manganese, copper, vanadium, titanium and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Ceramic materials useful for constructing the substrate may include any suitable refractory material, e.g., cordierite, mullite, cordierite-alumina, silicon nitride, zircon mullite, spodumene, alumina-silica-magnesia, zircon silicate, sillimanite, magnesium silicates, zircon, petalite, alumina, and aluminosilicates.

Within the context of the present invention, a monolithic flow-through substrate is preferred, which has a plurality of fine, parallel gas flow passages extending from an inlet to an outlet face of the substrate such that passages are open to fluid flow therethrough. The passages, which are essentially straight paths from their fluid inlet to their fluid outlet, are defined by walls on which the catalytic material is applied as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 900 or more gas inlet openings (i.e., cells) per square inch of cross section. For example, the substrate may have from about 400 to 900, more usually from about 600 to 750, cells per square inch (“cpsi”). The wall thickness of flow-through substrates may vary, with a typical range from 2 mils to 0.1 inches, A representative commercially available flowthrough substrate is a cordierite substrate having a cell density of 750 cpsi and a wall thickness of 2 mils, or a cell density of 600 cpsi and a wall thickness of 4 mils.

It is also possible that the substrate is a wall-flow substrate having a plurality of fine, parallel gas flow passages extending along from an inlet to an outlet face of the substrate wherein alternate passages are blocked at opposite ends. The configuration requiring the gas stream flow through the porous walls of the wall-flow substrate to reach the outlet face. The wall-flow substrates may contain up to about 700 cells per square inch (cpsi), for example about 100 to 400 cpsi and more typically about 200 to about 300 cpsi. The cross-sectional shape of the cells can vary as described above. The flow passages of the monolithic substrate are thin-walled channels, which can be of any suitable cross-sectional shape and size such as trapezoidal, rectangular, square, sinusoidal, hexagonal, oval, circular, etc. The wall thickness of wall-flow substrates may vary, with a typical range from 2 mils to 0.1 inches.

According to another aspect of the present invention, a process for the preparation of the layered catalytic article as described herein is provided, which includes
depositing a bottom coat slurry on the substrate to obtain a bottom layer;
depositing a top coat front zone slurry on the bottom layer of a certain length from one end of the substrate to obtain a front zone of a top layer; and
depositing a top coat rear zone slurry on the bottom layer of the remaining length of the substrate to obtain a rear zone of a top layer.

Generally, the slurries comprise catalyst particles of supported PGM(s), a solvent (e.g. water), an optional binder and an optional auxiliary such as surfactant, pH adjustor and thickener. For the bottom coat slurry, the catalyst particles of supported platinum and palladium components are comprised. For the top coat front zone slurry, the catalyst particles of supported platinum and rhodium components are comprised. For the top coat rear zone slurry, the catalyst particles of supported platinum, rhodium and optional palladium components are comprised. The support(s) for the PGMs in each slurry is(are) as descried herein above generally or particularly for the layered catalytic article according to the present invention.

Those catalyst particles of supported PGM(s) may be prepared by impregnating precursors of the PGM(s) such as soluble salts and/or complex thereof via conventional techniques such as dry impregnation (also called incipient wetness impregnation or capillary impregnation) or wet impregnation on respective supports, optionally followed by drying and/or calcining. Suitable precursors of the PGMs may be selected from ammine complex salts, hydroxyl salts, nitrates, carboxylic acid salts, ammonium salts, and oxides. Non-limiting examples include palladium nitrate, tetraammine palladium nitrate, rhodium nitrate, tetraamniine platinum acetate, and platinum nitrate, tetraammine platinum acetate and hexahydroxyplatinic acid diethanolamine salt ((HOCH₂CH₂NH₃)₂[Pt(OH)₆]).

The binder may be selected from alumina, boehmite, silica, zirconium acetate, colloidal zirconia, or zirconium hydroxide. When present, the binder is typically used in an amount of about 0.5 to about 5.0 wt % of the total washcoat loading.

The slurries may have a solid content for example in the range of about 20 to 60 wt %, more particularly about 30 to 50 wt. %. The slurries are often milled to reduce the particle size. Typically, the slurries will have a D₉₀ particle size of about 3.0 to about 40 microns, preferably about 10 to about 30 microns, more preferably less than about 20 microns, after milling, as measured by laser diffraction particle size distribution analyser.

Deposition of the slurries on the substrate or on the underlying coat may be carried out via any techniques known in the art. For example, the substrate may be dipped one or more times in a slurry or coated otherwise with a slurry to a desired length, and then dried at an elevated temperature (e.g., 100 to 150° C.) for a period (e.g., 10 minutes to 3 hours) and calcined at a higher temperature (e.g., 400 to 700° C.) typically for about 10 minutes to about 3 hours. The washcoat loading after calcination can be determined through calculation of the weight difference between the coated and uncoated substrate. As will be apparent to those of skill in the art, the washcoat loading can be modified by altering the slurry rheology. In addition, the deposition process including coating, drying and calcining to generate a washcoat can be repeated as needed to build a layer to the desired loading level or thickness, which means more than one washcoat may be applied.

According to a further aspect according to the present invention, an exhaust treatment system is provided which comprises the layered catalytic article as described herein located downstream of a gasoline engine. The layered catalytic article may be located downstream of a gasoline engine in a close-coupled position, in a position downstream of the close-coupled position, or both.

According to yet another aspect according to the present invention, a method for treating an exhaust stream is provided, which includes contacting the exhaust stream with the layered catalytic article or the exhaust treatment system as described herein.

The terms “exhaust stream”, “exhaust gas” and the like refer to any engine effluent gas that may also contain solid or liquid particulate matter.

The layered catalytic article according to the present invention is particularly useful for abatement of hydrocarbons, carbon monoxide and nitrogen oxides in an exhaust stream from a gasoline engine.

### EMBODIMENTS

Various embodiments are listed below. It will be understood that the embodiments listed below may be combined with all aspects and other embodiments in accordance with the scope of the invention.

Embodiment 1. A layered catalytic article, particularly useful for three-way conversion, which comprises
a) a top layer comprising a front zone and a rear zone, wherein the front zone comprises a palladium component and a rhodium component, supported individually or together on a support, and the rear zone comprises a platinum component, a rhodium component and optionally a palladium component, supported individually or together on a support;
b) a bottom layer comprising a platinum component and a palladium component supported individually or together on a support; and
c) a substrate, wherein the palladium component and the platinum component are present in the layered catalytic article at a Pd/Pt weight ratio in the range of about 20:1 to about 5:4, calculated as palladium and platinum elements.

Embodiment 2. The layered catalytic article according to Embodiment 1, wherein the rear zone comprises a platinum component, a rhodium component and a palladium component, supported individually or together on a support.

Embodiment 3. The layered catalytic article according to Embodiment 1 or 2, wherein the front zone of the top layer comprises about 20 to about 70% of the substrate length and the rear zone of the top layer comprises about 30 to about 80% of the substrate length, or the front zone of the top layer comprises about 30 to about 60% of the substrate length and the rear zone of the top layer comprises about 40 to about 70% of the substrate length, or the front zone of the top layer comprises about 30 to about 50% of the substrate length and the rear zone of the top layer comprises about 50 to about 70% of the substrate length.

Embodiment 4. The layered catalytic article according to any of preceding embodiments, wherein the weight ratio of the palladium component to the platinum component comprised in the layered catalytic article may be no less than about 4:3, no less than about 3:2, or no less than about 2:1, calculated as palladium and platinum elements.

Embodiment 5. The layered catalytic article according to any of preceding embodiments, wherein the weight ratio of the palladium component to the platinum component comprised in the layered catalytic article may be no greater than about 15:1, no greater than about 10:1, no greater than about 6:1 or no greater than about 5:1, or no greater than about 4:1, calculated as palladium and platinum elements.

Embodiment 6. The layered catalytic article according to any of preceding embodiments, wherein the weight ratio of the palladium component to the platinum component comprised in the layered catalytic article is in the range of about 15:1 to about 4:3, or about 10:1 to about 3:2, or about 6:1 to about 3:2, or about 5:1 to about 2:1 or about 4:1 to about 2:1, calculated as palladium and platinum elements.

Embodiment 7. The layered catalytic article according to any of preceding embodiments, wherein the weight ratio of the rhodium component to the sum of the palladium and platinum components in the layered catalytic article may be in the range of about 2:3 to about 1:200, or about 1:2 to about 1:50, or about 1:3 to about 1:20, or about 1:3 to about 1:10, calculated as respective elements.

Embodiment 8. The layered catalytic article according to any of preceding embodiments, wherein the weight ratio of the palladium component to the platinum component to the rhodium component in the layered catalytic article is in the range of about 10:1:0.2 to about 2:1:1 or about 5:1:0.5 to about 2:1:1, calculated as respective elements.

Embodiment 9. The layered catalytic article according to any of preceding embodiments, wherein the weight ratio of palladium component to the platinum component in the bottom layer is in the range of about 3:1 to about 2:3, or about 2.5:1 to about 1:1, calculated as respective elements.

Embodiment 10. The layered catalytic article according to any of preceding embodiments, wherein the palladium component and the rhodium component are loaded in the front zone of the top layer at a Pd/Rh weight ratio in the range of about 50:1 to about 1:1, or about 10:1 to about 1.5:1, or about 5:1 to about 1.5:1, or about 4:1 to about 2:1, calculated as respective elements.

Embodiment 11. The layered catalytic article according to any of preceding embodiments, wherein the platinum component and the rhodium component are loaded in the rear zone of the top layer at a Pt/Rh weight ratio in the range of about 10:1 to about 1:5, or about 2:1 to about 1:2, or about 1.5:1 to about 1:1.5, calculated as respective elements.

Embodiment 12. The layered catalytic article according to any of preceding embodiments, wherein the supports for each of the platinum component, palladium component and rhodium component are independently selected from refractory metal oxides, oxygen storage components and any combinations thereof.

Embodiment 13. The layered catalytic article according to any of preceding embodiments, which comprises:
a) a top layer comprising a front zone and a rear zone, wherein the front zone comprises a palladium component and a rhodium component, supported individually or together on a support, and the rear zone comprises a platinum component, a palladium component and a rhodium component; supported individually or together on a support;
b) a bottom layer comprising a platinum component and a palladium component supported individually or together on a support; and
c) a substrate, wherein the support in each case is independently a refractory metal oxide selected from alumina, lanthana doped alumina, lanthana-zirconia doped alumina; ceria doped alumina; zirconia, zirconia doped alumina, ceria-zirconia doped alumina, lanthana doped zirconia and lanthana-yttria doped zirconia, an oxygen storage component selected from ceria-zirconia composite oxide and rare earth-stabilized ceria-zirconia composite oxide, or any combinations thereof.

Embodiment 14. The layered catalytic article according to any of preceding embodiments, which comprises:
a) a top layer comprising a front zone and a rear zone, wherein the front zone comprises a palladium component individually supported on a combination of alumina and an oxygen storage component and a rhodium component individually supported on a combination of alumina or zirconia and an oxygen storage component, and the rear zone comprises a palladium component supported individually on a combination of alumina and an oxygen storage component, a platinum component supported on an oxygen storage component, and a rhodium component, wherein a part of the rhodium component is supported on the oxygen storage component together with the platinum component and the remaining part of the rhodium component is supported on alumina or zirconia, wherein the oxygen storage component in each case is independently selected from ceria-zirconia composite oxide and rare earth-stabilized ceria-zirconia composite oxide;
b) a bottom layer comprising a platinum component and a palladium component, wherein the platinum component is supported together with a part of palladium component on ceria doped alumina and the remaining part of the palladium component is supported on an oxygen storage component selected from ceria-zirconia composite oxide and rare earth-stabilized ceria-zirconia composite oxide; and
c) a substrate.

Embodiment 15. The layered catalytic article according to any of preceding embodiments, wherein the front zone of the top layer is substantially free of a platinum component or substantially free of any PGMs other than Pd and Rh.

Embodiment 16. The layered catalytic article according to any of preceding embodiments, wherein the rear zone of the top layer is substantially free of any PGMs other than Pd, Pt and Rh.

Embodiment 17. The layered catalytic article according to any of preceding embodiments, wherein the bottom layer is substantially free of a rhodium component or substantially free of any PGMs other than Pt and Pd.

Embodiment 18. The layered catalytic article according to any of preceding embodiments, wherein the palladium component supported on the oxygen storage component in the bottom layer comprises about 50% to about 95% or about 70% to about 95% of the total amount of the palladium component in the bottom layer.

Embodiment 19. The layered catalytic article according to any of preceding embodiments, wherein the rhodium component supported on the oxygen storage component in the rear zone of the top layer comprises about 50% to about 90% or about 60% to about 80% of the total amount of the rhodium component in the rear zone.

Embodiment 20. The layered catalytic article according to any of preceding embodiments, wherein the platinum component in the rear zone of the top layer comprises about 30% to about 70%, or about 40% to about 60%, or about 50% of the total amount of the platinum component in the layered catalytic article.

Embodiment 21. The layered catalytic article according to any of preceding embodiments, wherein the bottom layer is applied on the substrate and the top layer is applied on the bottom layer without any intermediate layers.

Embodiment 22. The layered catalytic article according to any of preceding embodiments, wherein the total loading of the top layer is in the range of about 1.5 to 4.0 g/in³ or about 2 to 3 g/in³ and the loading of the bottom layer is in the range of about 0.75 to 2.0 g/in³

Embodiment 23. The layered catalytic article according to any of preceding embodiments, wherein the substrate is a flow-through substrate or wall-flow substrate, preferably flow-through substrate.

Embodiment 24. A process for preparation of the layered catalytic article according to any of preceding embodiments, which includes
depositing a bottom coat slurry on the substrate to obtain a bottom layer;
depositing a top coat front zone slurry on the bottom layer of a certain length from one end of the substrate to obtain a front zone of a top layer; and
depositing a top coat rear zone slurry on the bottom layer of the remaining length of the substrate to obtain a rear zone of a top layer.

Embodiment 25. The process according to Embodiment 24, wherein each slimy comprises catalyst particles of supported PGM(s), a solvent, an optional binder and an optional auxiliary.

Embodiment 26. The process according to Embodiment 24, wherein the catalyst particles of supported PGM(s) are prepared by impregnating support materials with precursors of the PGMs selected from ammine complex salts, hydroxyl salts, nitrates, carboxylic acid salts, ammonium salts, and oxides.

Embodiment 27. The process according to Embodiment 26, wherein the precursor of Pt is hexahydroxyplatinic acid diethanolamine salt ((HOCH₂CH₂NH₃)₂[Pt(OH)₆]).

Embodiment 28. Use of the layered catalytic article according to any of embodiments 1 to 23 for abatement of hydrocarbons, carbon monoxide and nitrogen oxides in an exhaust stream.

Embodiment 29. An exhaust treatment system, which comprises the layered catalytic article according to any of embodiments 1 to 23 located downstream of a gasoline engine.

Embodiment 30. The exhaust treatment system according to Embodiment 29, wherein the layered catalytic article is located downstream of a gasoline engine in a close-coupled position, in an underfloor position, or both.

Embodiment 31. The exhaust treatment system according to Embodiment 29 or 30, wherein the layered catalytic article is followed directly or indirectly by a four-way catalytic converter.

Embodiment 32. A method for treating an exhaust stream, which includes contacting the exhaust stream with the layered catalytic article according to any of embodiments 1 to 23 or the exhaust treatment system according to any of Embodiments 29 to 31.

Embodiment 33. The method according to Embodiment 32, wherein the layered catalytic article is particularly useful for abatement of hydrocarbons, carbon monoxide and nitrogen oxides in an exhaust stream from a gasoline engine.

### EXAMPLES

Aspects of the present invention are more fully illustrated by the following examples, which are set forth to illustrate certain aspects of the present invention and are not to be construed as limiting thereof.

### Example 1 Preparation of a Layered Bi-Metal Catalytic Article (Reference, BMC-1, Pd/Pt/Rh 50/0/10, g/ft³)

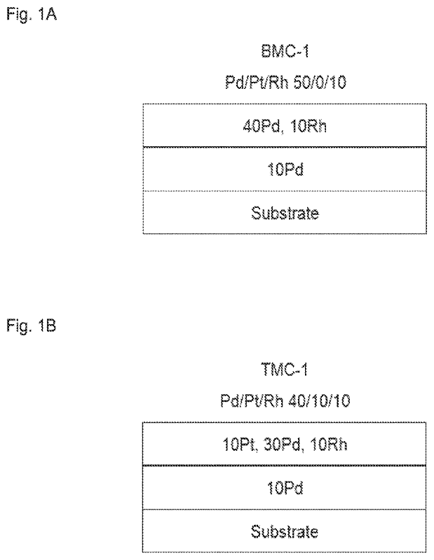

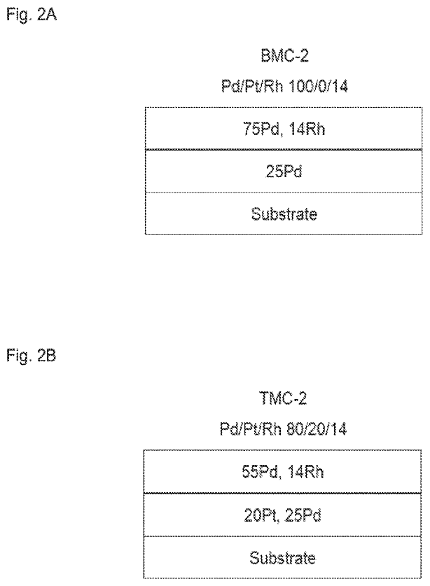

A catalytic article was prepared comprising a bottom coat having palladium (Pd) as the only PGM and a top coat having palladium (Pd) and rhodium (Rh) as the PGMs. A schematic representation of this catalytic article is provided in FIG. 1A.

Bottom Coat Slurry: 18.91 grams of 20% aqueous Pd-nitrate solution was impregnated onto 283 grams of alumina and 700 grams of ceria-zirconia (50% zirconia) via incipient wetness impregnation. The product was mixed with water and then milled to a D₉₀ of below 18 μm. The pH was adjusted around 3.0-4.0 by addition of nitric acid, and then 13 grams of alumina binder was added.

Top Coat Slurry:

A first component was prepared by impregnating 75.65 grams of 20% aqueous Pd-nitrate solution onto 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 37.83 grams of 10% aqueous Rh-nitrate solution onto 250 grams of alumina and 410 grams of cerin-zirconia (50% zirconia) via incipient wetness impregnation. The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrate with diameter of 118.4 mm and length of 90 mm, dried at 150° C. for 1 hour and then calcined at 500° C. for 2 hours. The bottom coat was obtained with a washcoat loading of 1.53 g/in³ and the Pd loading of the bottom coating is 10 g/ft³. The top coat slurry was then applied, dried at 150° C. for 1 hour and then calcined at 500° C. for 2 hours. The top coat was obtained with a washcoat loading of 2.45 g/in³ and the PGM loading of the top coat consists of 40 g/ft³ Pd and 10 g/ft³ Rh.

### Example 2 Preparation of a Layered Tri-Metal Catalytic Article (Reference, TMC-1, Pd/Pt/Rh 40/10/10, g/ft³)

A catalytic article was prepared comprising a bottom coat having palladium (Pd) as the only PGM and a top coat having palladium (Pd), platinum (Pt) and rhodium (Rh) as the PGMs. A schematic representation of this catalytic article is provided in FIG. 1B. This catalytic article (TMC-1) represents a variant of the catalytic article (BMC-1) by simple replacement of 20% Pd with Pt in the top coat.

Bottom Coat Slurry: 18.91 grams of 20% aqueous Pd-nitrate solution was impregnated onto 283 grams of alumina and 700 grams of ceria-zirconia (50% zirconia) via incipient wetness impregnation. The product was mixed with water and then milled to a D₉₀ of below 18 μm. The pH was adjusted around 3.0-4.0 by addition of nitric acid, and then 13 grams of alumina binder was added.

Top Coat Slurry:

A first component was prepared by firstly impregnating 7.09 grams of 16% aqueous hexahydroxyplatinic acid diethanolamine salt solution on 490 grams of alumina and 410 grams of ceria-zirconia (50% zirconia) and secondly impregnating 56.75 grams of 20% aqueous Pd-nitrate solution, via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by firstly impregnating 37.83 grams of 10% aqueous Rh-nitrate solution on 250 grams of alumina and 410 grams of ceria-zirconia (50% zirconia), and secondly impregnating 16.55 grams of 16% aqueous hexahydroxyplatinic acid diethanolamine salt solution, via incipient wetness impregnation. The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrate with diameter of 118.4 mm and length of 90 mm, dried at 150° C. for 1 hour and then calcined at 500° C. for 2 hours. The bottom coat was obtained with a washcoat loading of 1.53 g/in³ and the Pd loading of the bottom coating is 10 g/ft³. The top coat slurry was then applied, dried at 150° C. for 1 hour and calcined at 500° C. for 2 hours. The top coat was obtained with a washcoat loading of 2.45 g/in³ and the PGM loading of the top coat consists of 30 g/ft³ Pd, 10 g/ft³ Pt and 10 g/ft³ Rh.

### Example 3 Preparation of a Layered Bi-Metal Catalytic Article (Reference, BMC-2, Pd/Pt/Rh 100/0/14, g/ft³)

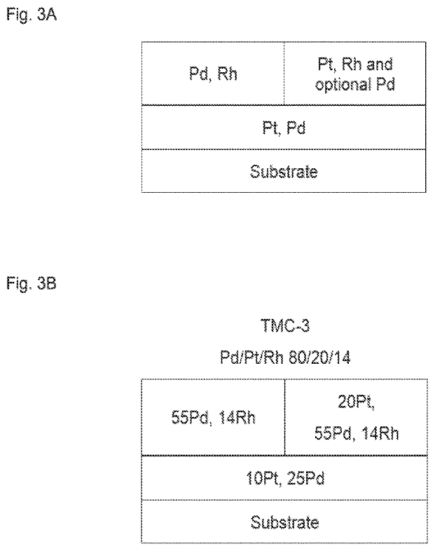

A catalytic article was prepared comprising a bottom coat having palladium (Pd) as the only PGM and a top coat having palladium (Pd) and rhodium (Rh) as the PGMs. A schematic representation of this catalytic article is provided in FIG. 2A.

Bottom Coat Slurry: 47.02 grams of 20% aqueous Pd-nitrate solution was impregnated onto 283 grams of alumina and 700 grams of ceria-zirconia (50% zirconia) via incipient wetness impregnation. The product was mixed with water and then milled to a D₉₀ of below 18 μm. The pH was adjusted around 3.0-4.0 by addition of nitric acid, and then 13 grams of alumina binder was added.

Top Coat Slurry:

A first component was prepared by impregnating 141.06 grams of 20% aqueous Pd-nitrate solution on 490 grams of alumina and 410 grams of cerin-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 52.66 grams of 10% aqueous Rh-nitrate solution on 250 grams of alumina and 410 grams of ceria-zirconia (50% zirconia). The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrates with diameter of 101.6 mm and length of 118 mm, dried at 150° C. for 1 hour and then calcined at 500° C. for 2 hours. The bottom coat was obtained with a washcoat loading of 1.54 g/in³ and the Pd loading of the bottom coating is 25 g/ft³. The top coat slurry was then applied, dried at 150° C. for 1 hour and calcined at 500° C. for 2 hours. The top coat was obtained with a washcoat loading of 2.47 g/in³ and the PGM loading of the top coat consists of 75 g/ft³ Pd and 14 g/ft³ Rh.

Three pieces of samples were prepared in accordance with this process.

### Example 4: Preparation of a Layered Tri-Metal Catalytic Article (Reference, TMC-2, Pd/Pt/Rh 80120/14, g/ft³)

A catalytic article was prepared which represents a variant of the catalytic article (BMC-2) by replacing 20% of total Pd loading with Pt and arranging Pt in the bottom coat. A schematic representation of this catalytic article is provided in FIG. 2B.

Bottom Coat Slurry:

A first component was prepared by firstly impregnating 46.67 grams of 16% aqueous hexahydroxyplatinic acid diethanolamine salt solution onto 283 grams of ceria-alumina (90% alumina) and secondly impregnating 7.47 grams of 20% aqueous Pd-nitrate solution, via incipient wetness impregnation. This step was followed by drying at 150° C. for 1 hour and then calcination at 500° C. for 2 hours to allow PGM fixation on the support. The product was mixed with water and then milled to a D₉₀ of below 18 μm.

A second component was prepared by impregnating 39.20 grams of 20% aqueous Pd-nitrate solution onto 700 grams of ceria-zirconia (50% zirconia) via incipient wetness impregnation. The product was mixed with water and then milled to a D₉₀ of below 18 μm.

The two components in form of slurries were blended. The pH was adjusted around 3.0-4.0 by addition of nitric acid, and then 13 grams of alumina binder was added.

Top Coat Slurry:

A first component was prepared by impregnating 102.67 grams of 20% aqueous Pd-nitrate solution onto 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 52.27 grams of 10% aqueous Rh-nitrate solution on 250 grams of alumina and 410 grams of ceria-zirconia (50% zirconia) via incipient wetness impregnation. The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrate with diameter of 101.6 mm and length of 118 mm, dried at 150° C. for 1 hour and then calcined at 500° C. for 2 hours. The bottom coat was obtained with a washcoat loading of 1.55 g/in³ and the PGM loading of the bottom coating consists of 20 g/ft³ Pt and 25 g/ft³ Pd. The top coat slurry was then applied, dried at 150° C. for 1 hour and calcined at 500° C. for 2 hours. The top coat was obtained with a washcoat loading of 2.46 g/in³ and the PGM loading of the top coat consists of 55 g/ft³ Pd and 14 g/ft³ Rh.

### Example 5: Preparation of a Layered Tri-Metal Catalytic Article (Inventive, TMC-3, Pd/Pt/Rh 80/20/14, g/ft³)

A catalytic article according to the present invention was prepared, comprising a bottom coat having palladium (Pd) and platinum (Pt) as the PGMs, and a top coat having palladium (Pd) and rhodium (Rh) as the PGMs in the front zone and having palladium (Pd), platinum (Pt) and rhodium (Rh) as the PGMs in the rear zone. A schematic representation of this catalytic article is provided in FIG. 3B.

Bottom Coat Slurry:

A first component was prepared by firstly impregnating 23.42 grams of 16% aqueous hexahydroxyplatinic acid diethanolamine salt solution on 283 grams of cerin-alumina (90% alumina), and secondly impregnating 3.75 grams of 20% aqueous Pd-nitrate solution, via incipient wetness impregnation. This step was followed by drying at 150° C. for 1 hour and then calcination at 500° C. for 2 hours to allow PGM fixation on the support. The product was mixed with water and then milled to a D₉₀ of below 18 μm.

A second component was prepared by impregnating 43.10 grams of 20% aqueous Pd-nitrate solution on 700 grams of ceria-zirconia (50% zirconia) via incipient wetness impregnation. The product was mixed with water and then milled to a D₉₀ of below 18 μm.

The two components in form of slurries were blended. The pH was adjusted around 3.0-4.0 by addition of nitric acid, and then 13 grams of alumina binder was added.

Top Coat Front Zone Slurry:

A first component was prepared by impregnating 103.06 grams of 20% aqueous Pd-nitrate solution on 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 52.46 grams of 10% aqueous Rh-nitrate solution on 250 grams of alumina and 410 grams of cerin-zirconia (50% zirconia) via incipient wetness impregnation. The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

Top Coat Rear Zone Slurry:

A first component was prepared by impregnating 103.06 grams of 20% aqueous Pd-nitrate solution on 490 grams of alumina and 410 grams of cerin-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 22.24 grams of 10% aqueous Rh-nitrate solution on 250 grams of alumina via incipient wetness impregnation. The product was mixed with water and then milled to a D₉₀ of below 18 μm.

A third component was prepared by firstly impregnating 30.22 grams of 10% aqueous Rh-nitrate solution on 410 grams of ceria-zirconia (50% zirconia) and secondly impregnating 46.84 grams of 16% aqueous hexahydroxyplatinic acid diethanolamine salt solution, via incipient wetness impregnation. This step was followed by drying at 150° C. for 1 hour and then calcination at 500° C. for 2 hours to allow PGM fixation on the support. The product was mixed with water and then milled to a D₉₀ of below 18 μm.

The three components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrate with diameter of 101.6 mm and length of 118 mm, dried at 150° C. for 1 hour and then calcined at 500° C. for 2 hours. The bottom coat was obtained with a washcoat loading of 1.54 g/in³ and a PGM loading consisting of 10 g/ft³ Pt and 25 g/ft³ Pd. The top coat front zone slurry was then applied to ½ length of the substrate from one end and dried at 150° C. for 1 hour, and subsequently the top coat rear zone slurry was applied to the remaining ½ length of the substrate and dried at 150° C. for 1 hour. The resulting product was calcined at 500° C. for 2 hours. The top coat was obtained with a washcoat loading of 2.47 g/in³, a PGM loading of the front zone consisting of 55 g/ft³ of Pd and 14 g/ft³ of Rh, and a PGM loading of the rear zone consisting of 20 g/ft³ Pt, 55 g/ft³ Pd and 14 g/ft³ Rh.

### Example 6: Preparation of a Layered Bi-Metal Catalytic Article (Reference, BMC-3, Pd/Pt/Rh, 32.5/0/10, g/ft³)

A catalytic article was prepared comprising a bottom coat having palladium (Pd) as the only PGM, and a top coat having a combination of palladium (Pd) and rhodium (Rh) as the PGMs in both front zone and rear zones. A schematic representation of this catalytic article is provided in FIG. 4A.

Bottom coat slurry: 18.91 grams of 20% aqueous Pd-nitrate solution was impregnated onto 283 grams of alumina and 700 grams of ceria-zirconia (50% zirconia) via incipient wetness impregnation. The product was mixed with water and then milled to a D₉₀ of below 18 μm. The pH was adjusted around 3.0-4.0 by addition of nitric acid, and then 13 grams of alumina binder was added.

Top Coat Front Zone Slurry:

A first component was prepared by impregnating 75.65 grams of 20% aqueous Pd-nitrate solution onto 490 grams of alumina and 410 grams of cerin-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 37.83 grams of 10% aqueous Rh-nitrate solution on 250 grams of zirconia and 410 grams of ceria-zirconia (50% zirconia) via incipient wetness impregnation. The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

Top Coat Rear Zone Slurry:

A first component was prepared by impregnating 9.46 grams of 20% aqueous Pd-nitrate solution on 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 37.83 grams of 10% aqueous Rh-nitrate solution on 250 grams of zirconia and 410 grams of ceria-zirconia (50% zirconia) via incipient wetness impregnation. The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrate with diameter of 118.4 mm and length of 90 mm, dried at 150° C. for 1 hour and then calcined at 500° C. for 2 hours. The bottom coat was obtained with a washcoat loading of 1.53 g/in³ and a PGM loading consisting of 10 g/ft³ Pd. The top coat front zone slurry was then applied to ½ length of the substrate from one end and dried at 150° C. for 1 hour, and subsequently the top coat rear zone slurry was applied to the remaining ½ length of the substrate and dried at 150° C. for 1 hour. The resulting product was calcined at 500° C. for 2 hours. The top coat was obtained with a washcoat loading of 2.45 g/in³; a PGM loading of the front zone consisting of 40 g/ft³ Pd and 10 g/ft³ Rh, and a PGM loading of the rear zone consisting of 5 g/ft³ Pd and 10 g/ft³ Rh.

### Example 7: Preparation of a Layered Tri-Metal Catalytic Article (Inventive, TMC-4, Pd/Pt/Rh 22.5/10/10, g/ft³)

A catalytic article according to the present invention was prepared, comprising a bottom coat having palladium (Pd) and platinum (Pt) as the PGMs, and a top coat having palladium (Pd) and rhodium (Rh) as the PGMs in the front zone and having palladium (Pd), platinum (Pt) and rhodium (Rh) as the PGMs in the rear zone. A schematic representation of this catalytic article is provided in FIG. 4B.

Bottom Coat Slurry:

A first component was prepared by firstly impregnating 11.82 grams of 16% aqueous hexahydroxyplatinic acid diethanolamine salt solution on 283 grams of cerin-alumina (90% alumina), and secondly impregnating 1.87 grams of 20% aqueous Pd-nitrate solution, via incipient wetness impregnation. This step was followed by drying at 150° C. for 1 hour and then calcination at 500° C. for 2 hours to allow PGM fixation on the support. The product was mixed with water and then milled to a D₉₀ of below 18 μm.

A second component was prepared by impregnating 7.59 grams of 20% aqueous Pd-nitrate solution on 700 grams of ceria-zirconia (50% zirconia) via incipient wetness impregnation. The product was mixed with water and then milled to a D₉₀ of below 18 μm.

The two components in form of slurries were blended. The pH was adjusted around 3.0-4.0 by addition of nitric acid, and then 13 grams of alumina binder was added.

Top Coat Front Zone Slurry:

A first component was prepared by impregnating 62.40 grams of 20% aqueous Pd-nitrate solution on 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 37.83 grams of 10% aqueous Rh-nitrate solution on 250 grams of zirconia and 410 grams of ceria-zirconia (50% zirconia) via incipient wetness impregnation. The product was mixed with water and then milled to a D₉₀ of below 18 μm.

The two components in form of slurries were blended. The pH was adjusted around 7.0-9.0 by addition of barium hydroxide and nitric acid, and then 20 grams of alumina binder was added.

Top Coat Rear Zone Slurry:

A first component was prepared by impregnating 3.78 grams of 20% aqueous Pd-nitrate solution on 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 16.01 grams of 10% aqueous Rh-nitrate solution on 250 grams of zirconia via incipient wetness impregnation. The product was mixed with water and then milled to a D₉₀ of below 18 μm.

A third component was prepared by firstly impregnating 21.82 grams of 10% aqueous Rh-nitrate solution on 410 grams of ceria-zirconia (50% zirconia) and secondly impregnating 23.64 grams of 16% aqueous hexahydroxyplatinic acid diethanolamine salt solution, via incipient wetness impregnation. This step was followed by drying at 150° C. for 1 hour and then calcination at 500° C. for 2 hours to allow PGM fixation on the support. The product was mixed with water and then milled to a D₉₀ of below 18 μm.

The three components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrate with diameter of 118.4 mm and length of 90 mm, dried at 150° C. for 1 hour and then calcined at 500° C. for 2 hours. The bottom coat was obtained with a washcoat loading of 1.53 g/in³ and a PGM loading consisting of 5 g/ft³ Pt and 5 g/ft³ Pd. The top coat front zone slurry was then applied to ½ length of the substrate from one end and dried at 150° C. for 1 hour, and subsequently the top coat rear zone slurry was applied to the remaining ½ length of the substrate and dried at 150° C. for 1 hour. The resulting product was calcined at 500° C. for 2 hours. The top coat was obtained with a washcoat loading of 2.45 g/in³, a PGM loading of the front zone consisting of 33 g/ft³ Pd and 10 g/ft³ Rh, and a PGM loading of the rear zone consisting of 10 g/ft³ of Pt, 2 g/ft³ of Pd and 10 g/ft³ of Rh.

### Example 8: Preparation of a Layered Tri-Metal Catalytic Article (Comparative, TMC-5, Pd/Pt/Rh 50/50/14, g/ft³)

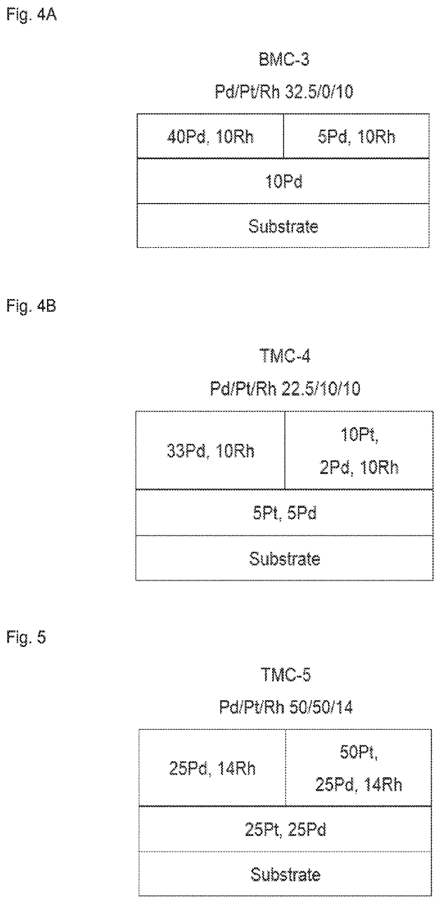

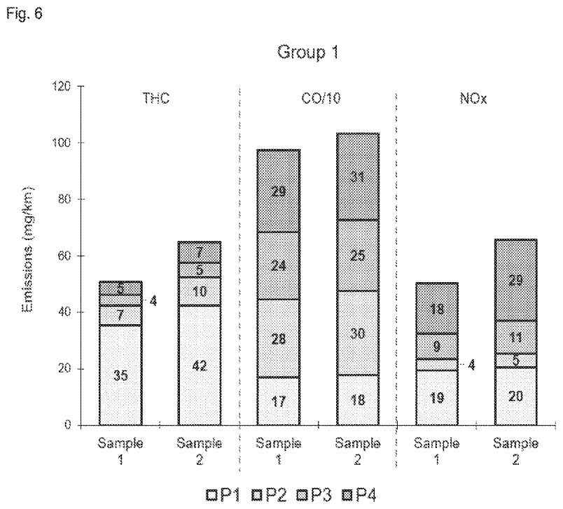

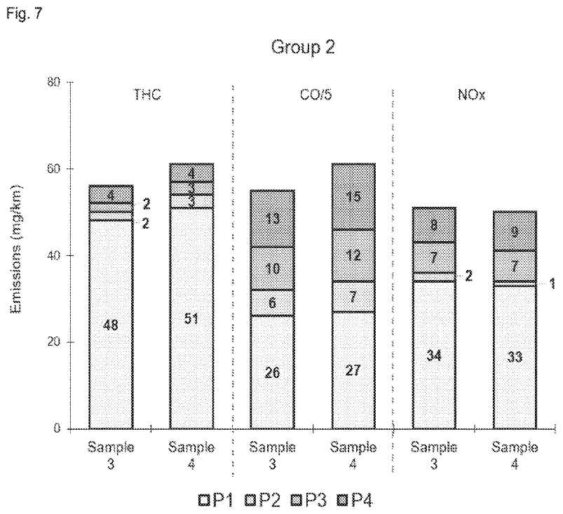

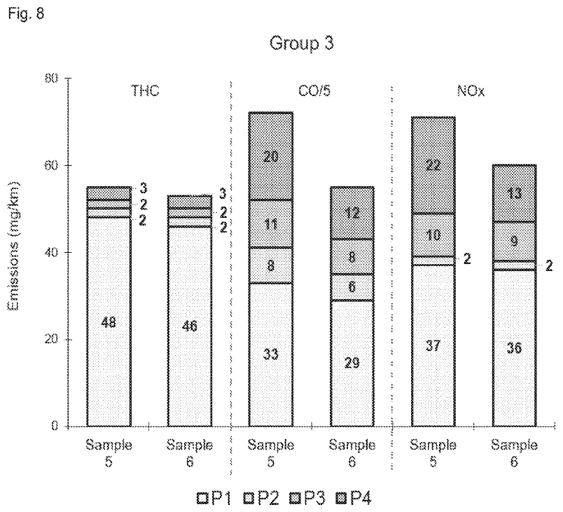

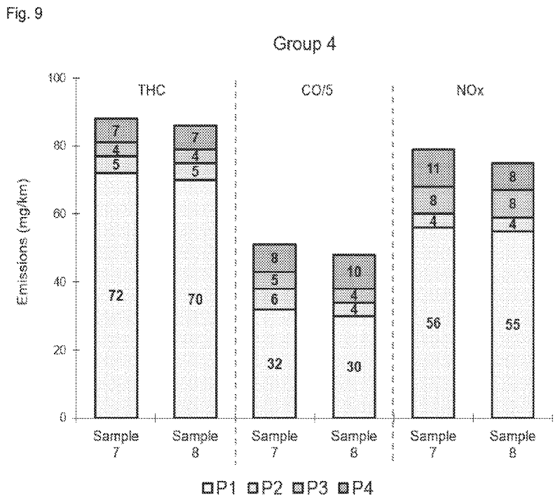

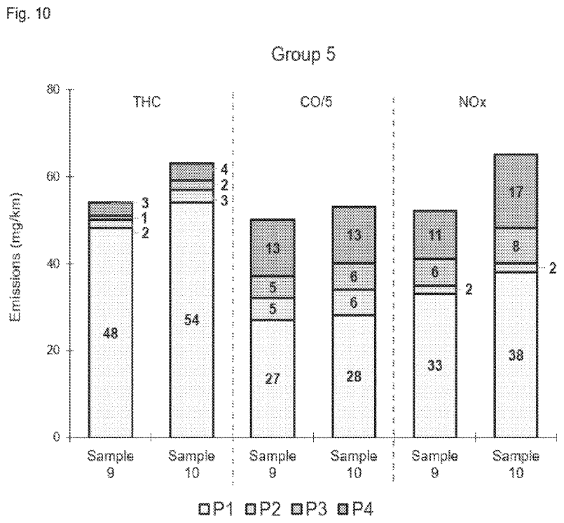

A catalytic article having the inventive zoned configuration but having a lower Pd/Pt ratio was prepared, comprising a bottom coat having palladium (Pd) and platinum (Pt) as the PGMs, and a top coat having palladium (Pd) and rhodium (Rh) as the PGMs in the front zone and having palladium (Pd), platinum (Pt) and rhodium (Rh) as the PGMs in the rear zone. A schematic representation of this catalytic article is provided in FIG. 5.

Bottom Coat Slurry:

A first component was prepared by firstly impregnating 58.55 grams of 16% aqueous hexahydroxyplatinic acid diethanolamine salt solution on 283 grams of cerin-alumina (90% alumina), and secondly impregnating 9.38 grams of 20% aqueous Pd-nitrate solution, via incipient wetness impregnation. This step was followed by drying at 150° C. for 1 hour and then calcination at 500° C. for 2 hours to allow PGM fixation on the support. The product was mixed with water and then milled to a D₉₀ of below 18 μm.

A second component was prepared by impregnating 37.47 grams of 20% aqueous Pd-nitrate solution on 700 grams of ceria-zirconia (50% zirconia) via incipient wetness impregnation. The product was mixed with water and then milled to a D₉₀ of below 18 μm.

The two components in form of slurries were blended. The pH was adjusted around 3.0-4.0 by addition of nitric acid, and then 13 grams of alumina binder was added.

Top Coat Front Zone Slurry:

A first component was prepared by impregnating 46.85 grams of 20% aqueous Pd-nitrate solution on 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 52.46 grams of 10% aqueous Rh-nitrate solution on 250 grams of alumina and 410 grams of ceria-zirconia (50% zirconia) via incipient wetness impregnation. The product was then milled to a D₉₀ of below 18 μm.

The two components in form of slurries were blended. The pH was adjusted around 7.0-9.0 by addition of barium hydroxide and nitric acid, and then 20 grams of alumina binder was added.

Top Coat Rear Zone Slurry:

A first component was prepared by impregnating 46.85 grams of 20% aqueous Pd-nitrate solution on 490 grams of alumina and 410 grams of ceria-zirconia (50% zirconia) via incipient wetness impregnation. This step was followed by drying at 150° C. for 1 hour and then calcination at 500° C. for 2 hours to allow PGM fixation on the supports. The product was mixed with water and then milled to a D₉₀ of below 18 μm.

A second component was prepared by impregnating 22.24 grams of 10% aqueous Rh-nitrate solution on 250 grams of alumina via incipient wetness impregnation. The product was mixed with water and then milled to a D₉₀ of below 18 μm.

A third component was prepared by firstly impregnating 30.22 grams of 10% aqueous Rh-nitrate solution on 410 grams of ceria-zirconia (50% zirconia) and secondly impregnating 117.12 grams of 16% aqueous hexahydroxyplatinic acid diethanolamine salt solution, via incipient wetness impregnation. This step was followed by drying at 150° C. for 1 hour and then calcination at 500° C. for 2 hours to allow PGM fixation on the support. The product was mixed with water and then milled to a D₉₀ of below 18 μm.

The three components in form of slurries were blended. The pH was adjusted around 7.0-9.0 by addition of barium hydroxide and nitric acid, and then 20 grams of alumina binder was added.

The bottom coat slurry was coated onto a 750/2 (cpsi/mils) flow-through ceramic substrate with diameter of 101.6 mm and length of 118 mm, dried at 150° C. for 1 hour and then calcined at 500° C. for 2 hours. The bottom coat was obtained with a washcoat loading of 1.55 g/in³ and a PGM loading consisting of 25 g/ft³ Pt and 25 g/ft³ Pd. The top coat front zone slurry was then applied to ½ length of the substrate from one end and dried at 150° C. for 1 hour, and subsequently the top coat rear zone slurry was applied to the remaining ½ length of the substrate and dried at 150° C. for 1 hour. The resulting product was calcined at 500° C. for 2 hours. The top coat was obtained with a washcoat loading of 2.46 g/in³, a PGM loading of the front zone consisting of 25 g/ft³ Pd and 14 g/ft³ Rh, and a PGM loading of the rear zone consisting of 50 g/ft³ Pt, 25 g/ft³ Pd and 14 g/ft³ Rh.

### Example 9 Catalytic Performance Test

The catalytic article samples as summarized in Table 1 were exothermically aged on an GM 8.1 L V8 engine at an inlet temperature of 875° C.

TABLE 1

| | | | Aging |
|---|---|---|---|
| | | | Time |
| Sample | Composition | Size, D × L | (h) |
| 1 | BMC-1 (Ex. 1, Pd/Pt 50/0) | 118.4 mm × 90 mm | 50 |
| 2 | TMC-1 (Ex. 2, Pd/Pt 4/1) | 118.4 mm × 90 mm | 50 |
| 3 | BMC-2 (Ex. 3, Pd/Pt 100/0) | 101.6 mm × 118 mm | 100 |
| 4 | TMC-2 (Ex. 4, Pd/Pt 4/1) | 101.6 mm × 118 mm | 100 |
| 5 | BMC-2 (Ex. 3, Pd/Pt 100/0) | 101.6 mm × 118 mm | 200 |
| 6 | TMC-3 (Ex. 5, Pd/Pt 4/1) | 101.6 mm × 118 mm | 200 |
| 7 | BMC-3 (Ex. 6, Pd/Pt 32.5/0) | 118.4 mm × 90 mm | 100 |
| 8 | TMC-4 (Ex. 7, Pd/Pt 2.25/1) | 118.4 mm × 90 mm | 100 |
| 9 | BMC-2 (Ex. 3, Pd/Pt 100/0) | 101.6 mm × 118 mm | 100 |
| 10 | TMC-5 (Ex. 8, Pd/Pt 1/1) | 101.6 mm × 118 mm | 100 |

The aged samples were tested on a Daimler 2.0 L engine bench using the World-wide Light-duty vehicle Test Cycle (WLTC) in accordance with China-6 “Type I” (GB 18352.6-2016). The performance of the test samples was evaluated by measuring the tail-pipe total hydrocarbons (THC), CO and NOx emissions from following four phases included in one test cycle according to China-6 “Type I”:
P1: Low speed phase from 0 to 589 seconds,
P2: Medium speed phase from 590 to 1022 seconds,
P3: High speed phase from 1023 to 1477 seconds, and
P4: Extra high speed phase from 1478 to 1800 seconds.

Each sample was tested three times to provide average test values as the test results which were summarized in Tables 2 to 4.

TABLE 2
Tail-pipe THC emissions

| | Group 1 | | Group 2 | | Group 3 | | Group 4 | | Group 5 | |
|---|---|---|---|---|---|---|---|---|---|---|
| THC, | Sample | Sample | Sample | Sample | Sample | Sample | Sample | Sample | Sample | Sample |
| mg/km | 1 | 2 | 3 | 4 | 5 | 6 | 7 | 8 | 9 | 10 |
| P1 | 35 | 42 | 48 | 51 | 48 | 46 | 72 | 70 | 48 | 54 |
| P2 | 7 | 10 | 2 | 3 | 2 | 2 | 5 | 5 | 2 | 3 |
| P3 | 4 | 5 | 2 | 3 | 2 | 2 | 4 | 4 | 1 | 2 |
| P4 | 5 | 7 | 4 | 4 | 3 | 3 | 7 | 7 | 3 | 4 |
| Sum | 51 | 64 | 56 | 61 | 55 | 53 | 88 | 86 | 54 | 63 |

TABLE 3
Tail-pipe CO emissions

| | Group 1 | | Group 2 | | Group 3 | | Group 4 | | Group 5 | |
|---|---|---|---|---|---|---|---|---|---|---|
| CO, | Sample | Sample | Sample | Sample | Sample | Sample | Sample | Sample | Sample | Sample |
| mg/km | 1 | 2 | 3 | 4 | 5 | 6 | 7 | 8 | 9 | 10 |
| P1 | 168 | 176 | 129 | 134 | 163 | 143 | 160 | 149 | 133 | 142 |
| P2 | 277 | 298 | 29 | 34 | 41 | 30 | 29 | 22 | 24 | 31 |
| P3 | 239 | 253 | 48 | 60 | 54 | 39 | 24 | 19 | 25 | 29 |
| P4 | 288 | 306 | 65 | 76 | 99 | 60 | 42 | 52 | 67 | 64 |
| Sum | 972 | 1033 | 271 | 305 | 356 | 272 | 255 | 241 | 248 | 266 |

TABLE 4
Tail-pipe NOx emissions

| | Group 1 | | Group 2 | | Group 3 | | Group 4 | | Group 5 | |
|---|---|---|---|---|---|---|---|---|---|---|
| NOx, | Sample | Sample | Sample | Sample | Sample | Sample | Sample | Sample | Sample | Sample |
| mg/km | 1 | 2 | 3 | 4 | 5 | 6 | 7 | 8 | 9 | 10 |
| P1 | 19 | 20 | 34 | 33 | 37 | 36 | 56 | 55 | 33 | 38 |
| P2 | 4 | 5 | 2 | 1 | 2 | 2 | 4 | 4 | 2 | 2 |
| P3 | 9 | 11 | 7 | 7 | 10 | 9 | 8 | 8 | 6 | 8 |
| P4 | 18 | 29 | 8 | 9 | 22 | 13 | 11 | 8 | 11 | 17 |
| Sum | 50 | 65 | 51 | 50 | 71 | 60 | 79 | 75 | 52 | 65 |

It is to be understood that the composition of the engine exhaust gas may vary depending on the engine conditions such as hours and distance the engine has run, for example. The samples in the same group as shown in above Tables were tested under substantially same engine conditions to ensure the inlet exhaust gases for the test samples have substantially same compositions and allow for the comparison between the samples with respect to measured emissions.

As can be seen from the measured emissions, Sample 2 (reference) shows 25% higher THC, 6% higher CO and 30% higher NOx compared with Sample 1 (reference). The comparison between the test results of Sample 1 and Sample 2 confirmed that incorporation of Pt by simple replacing a portion of Pd in a TWC catalyst will result in worse emissions of THC, CO and NOx, as generally recognized in the art.

Likewise, Sample 4 (reference), a variant of Sample 3 obtained by replacing 20% of total Pd loading with Pt and arranging Pt in the bottom coat, shows 9% higher THC and 13% higher CO compared with Sample 3 (reference).

Contrary to the tendency that replacement of Pd with Pt will result in worse emissions, Sample 6 having a catalytic composition and configuration according to the present invention shows 4% lower THC, 24% lower CO and 15% lower NOx, compared with Sample 5 (reference). Likewise, Sample 8 having a catalytic composition and configuration according to the present invention shows 2% lower THC, 5% lower CO and 5% lower NOx, compared with Sample 7 (reference).

The comparison between the test results of Sample 10 (comparative) and Sample 9 (reference) shows that the positive effect achieved by incorporation of Pt in a TWC catalyst having the zoned configuration according to the present invention will disappear if 50% of the total Pd loading was replaced with Pt. Sample 10 having a configuration according to the present invention but having a composition out of the inventive scope shows 17% higher THC, 7% higher CO and 25% higher NOx, compared with Sample 9 (reference).

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A layered catalytic article, which comprises
a) a top layer comprising a front zone and a rear zone, wherein the front zone comprises a palladium component and a rhodium component, supported individually or together on a support, and the rear zone comprises a platinum component, a rhodium component and optionally a palladium component, supported individually or together on a support;
b) a bottom layer comprising a platinum component and a palladium component supported individually or together on a support; and
c) a substrate,
wherein the palladium component and the platinum component are present in the layered catalytic article at a Pd/Pt weight ratio in the range of about 20:1 to about 5:4, calculated as palladium and platinum elements.

2. The layered catalytic article according to claim 1, wherein the rear zone comprises a platinum component, a rhodium component and a palladium component, supported individually or together on a support.

3. The layered catalytic article according to claim 1, wherein the front zone of the top layer comprises about 20 to about 70% of the substrate length and the rear zone of the top layer comprises about 30 to about 80% of the substrate length, or the front zone of the top layer comprises about 30 to about 60% of the substrate length and the rear zone of the top layer comprises about 40 to about 70% of the substrate length, or the front zone of the top layer comprises about 30 to about 50% of the substrate length and the rear zone of the top layer comprises about 50 to about 70% of the substrate length.

4. The layered catalytic article according to claim 1, wherein the weight ratio of the palladium component to the platinum component comprised in the layered catalytic article is in the range of about 15:1 to about 4:3, or about 10:1 to about 3:2, or about 6:1 to about 3:2, or about 5:1 to about 2:1 or about 4:1 to about 2:1, calculated as palladium and platinum elements.

5. The layered catalytic article according to claim 1, wherein the weight ratio of the rhodium component to the sum of the palladium and platinum components in the layered catalytic article may be in the range of about 2:3 to about 1:200, or about 1:2 to about 1:50, or about 1:3 to about 1:20, or about 1:3 to about 1:10, calculated as respective elements.

6. The layered catalytic article according to claim 1, wherein the weight ratio of the palladium component to the platinum component to the rhodium component in the layered catalytic article is in the range of about 10:1:0.2 to about 2:1:1 or about 5:1:0.5 to about 2:1:1, calculated as respective elements.

7. The layered catalytic article according to claim 1, wherein the palladium component and the rhodium component are loaded in the front zone of the top layer at a Pd/Rh weight ratio in the range of about 50:1 to about 1:1, or about 10:1 to about 1.5:1, or about 5:1 to about 1.5:1, or about 4:1 to about 2:1, calculated as respective elements.

8. The layered catalytic article according to claim 1, wherein the platinum component and the rhodium component are loaded in the rear zone of the top layer at a Pt/Rh weight ratio in the range of about 10:1 to about 1:5, or about 2:1 to about 1:2, or about 1.5:1 to about 1:1.5, calculated as respective elements.

9. The layered catalytic article according to claim 1, wherein the supports for each of the platinum component, palladium component and rhodium component are independently selected from the group consisting of refractory metal oxides, oxygen storage components and any combinations thereof.

10. The layered catalytic article according to claim 1, which comprises:
a) a top layer comprising a front zone and a rear zone, wherein the front zone comprises a palladium component and a rhodium component, supported individually or together on a support, and the rear zone comprises a platinum component, a palladium component and a rhodium component, supported individually or together on a support;
b) a bottom layer comprising a platinum component and a palladium component supported individually or together on a support; and
c) a substrate,
wherein the support in each case is independently a refractory metal oxide selected from the group consisting of alumina, lanthana doped alumina, lanthana-zirconia doped alumina, ceria doped alumina, zirconia, zirconia doped alumina, ceria-zirconia doped alumina, lanthana doped zirconia and lanthana-yttria doped zirconia, or an oxygen storage component selected from the group consisting of ceria-zirconia composite oxide and rare earth-stabilized ceria-zirconia composite oxide, and combinations thereof.

11. The layered catalytic article according to claim 1, which comprises:
a) a top layer comprising a front zone and a rear zone, wherein the front zone comprises a palladium component individually supported on a combination of alumina and an oxygen storage component and a rhodium component individually supported on a combination of alumina or zirconia and an oxygen storage component, and the rear zone comprises a palladium component supported individually on a combination of alumina and an oxygen storage component, a platinum component supported on an oxygen storage component, and a rhodium component, wherein a part of the rhodium component is supported on the oxygen storage component together with the platinum component and the remaining part of the rhodium component is supported on alumina or zirconia, wherein the oxygen storage component in each case is independently selected from the group consisting of ceria-zirconia composite oxide and rare earth-stabilized ceria-zirconia composite oxide;
b) a bottom layer comprising a platinum component and a palladium component, wherein the platinum component is supported together with a part of palladium component on ceria doped alumina and the remaining part of the palladium component is supported on an oxygen storage component selected from the group consisting of ceria-zirconia composite oxide and rare earth-stabilized ceria-zirconia composite oxide; and
c) a substrate.

12. The layered catalytic article according to claim 1, wherein the front zone of the top layer is substantially free of a platinum component or substantially free of any PGMs other than Pd and Rh.

13. The layered catalytic article according to claim 1, wherein the rear zone of the top layer is substantially free of any PGMs other than Pd, Pt and Rh.

14. The layered catalytic article according to claim 1, wherein the bottom layer is substantially free of a rhodium component or substantially free of any PGMs other than Pt and Pd.

15. The layered catalytic article according to claim 1, wherein the palladium component supported on the oxygen storage component in the bottom layer comprises about 50% to about 95% or about 70% to about 95% of the total amount of the palladium component in the bottom layer.

16. The layered catalytic article according to claim 1, wherein the rhodium component supported on the oxygen storage component in the rear zone of the top layer comprises about 50% to about 90% or about 60% to about 80% of the total amount of the rhodium component in the rear zone.

17. The layered catalytic article according to claim 1, wherein the platinum component in the rear zone of the top layer comprises about 30% to about 70%, or about 40% to about 60%, or about 50% of the total amount of the platinum component in the layered catalytic article.

18. The layered catalytic article according to claim 1, wherein the bottom layer is applied on the substrate and the top layer is applied on the bottom layer without any intermediate layers.

19. The layered catalytic article according to claim 1, wherein the substrate is a flow-through substrate.

20. A process for preparation of the layered catalytic article according to claim 1, which includes
depositing a bottom coat slurry on the substrate to obtain a bottom layer;
depositing a top coat front zone slurry on the bottom layer of a certain length from one end of the substrate to obtain a front zone of a top layer; and
depositing a top coat rear zone slurry on the bottom layer of the remaining length of the substrate to obtain a rear zone of a top layer.

21. A method of using the layered catalytic article according to claim 1, the method comprising using the layered catalytic article for abatement of hydrocarbons, carbon monoxide and nitrogen oxides in an exhaust stream.

22. An exhaust treatment system, which comprises the layered catalytic article according to claim 1 located downstream of a gasoline engine.

23. The exhaust treatment system according to claim 22, wherein the layered catalytic article is located downstream of a gasoline engine in a close-coupled position, in an underfloor position, or both.

24. The exhaust treatment system according to claim 22, wherein the layered catalytic article is followed directly or indirectly by a four-way catalytic converter.

25. A method for treating an exhaust stream, the method comprising contacting the exhaust stream with the layered catalytic article according to claim 1.

26. The method according to claim 25, wherein the layered catalytic article abates hydrocarbons, carbon monoxide and nitrogen oxides in the exhaust stream.
